(19) United States
(12) Patent Application Publication
(10) Pub. No.: US 2026/0121165 A1
(43) Pub. Date: Apr. 30, 2026

(54) INTER-CELL COOLING UNIT WITH COMPRESSION PROPERTIES, BATTERY MODULE AND METHOD FOR PRODUCING AN INTER-CELL COOLING UNIT

(71) Applicant: AUDI AG, Ingolstadt (DE)

(72) Inventors: Anja JÄSCHKE, Beilngries (DE); Eduard MAIN, Buxheim (DE); Maria SAUER, Arnstein-Schwebenried (DE); Olaf SCHARGE, Braunschweig (DE)

(73) Assignee: AUDI AG, Ingolstadt (DE)

(21) Appl. No.: 19/366,695

(22) Filed: Oct. 23, 2025

(30) Foreign Application Priority Data
Oct. 25, 2024 (DE) 102024131140.1

(51) Int. Cl. H01M 10/6568; B60L 50/64; H01M 10/613; H01M 10/625; H01M 10/653; H01M 10/6557

(52) U.S. Cl. CPC H01M 10/6568; H01M 10/613; H01M 10/625; H01M 10/653; H01M 10/6557; B60L 50/64; H01M 2220/20

(57) ABSTRACT

An inter-cell cooling unit for arrangement between two battery cells of a battery module. The inter-cell cooling unit has an outer casing that provides a first cooling side and a second cooling side opposite the first cooling side in the first direction, and at least one first cooling channel section extending within the outer casing that can be flowed through by a coolant. The inter-cell cooling unit includes a multi-layer compression component which is arranged within the outer casing and which includes at least one first outer layer made of a first plastic material and a compression layer made of a second plastic material which is more compressible than the first plastic material and which is flatly adjacent to the first outer layer with respect to the first direction.

### FIELD

The invention relates to an inter-cell cooling unit for arrangement between two battery cells of a battery module, wherein the inter-cell cooling unit has an outer casing which provides a first cooling side and a second cooling side opposite the first cooling side with respect to a first direction, and at least one first cooling channel section running within the outer casing, through which section a coolant can flow. Furthermore, the invention also relates to a battery module for a vehicle and to a method for producing an inter-cell cooling unit.

### BACKGROUND

Battery cells of batteries, for example automotive batteries, are typically cooled by a cooling unit. There are various options for implementing such a cooling device. Most concepts are based on the battery cells being placed on a cooling plate, for example in the form of a cell stack or module. However, only a small part of the cell surface of each battery cell can be cooled. More effective cooling of battery cells can be achieved if they are cooled on their sides having the largest surface area. This can be achieved in particular by arranging a cooling structure between two battery cells, for example of a cell stack, and bringing it into contact with the sides with the largest surface area of the adjacent battery cells. The problem with positioning between battery cells, however, is that such a cooling structure positioned between two battery cells must withstand very high compressive forces. On the one hand, these are caused by the fact that the battery cells of a cell stack are often tensioned in the stack direction, and on the other hand, the battery cells also swell over the course of their service life and also during charging and partially shrink again during discharging. While a rigid cooling plate positioned between the cells can prevent excessive compression of the cooling channels, such a rigid plate does not provide any space for the cells to expand during swelling, which in turn severely impacts the service life of the battery cells. To avoid this, additional inter-cell elements would have to be provided, which would require additional installation space and/or reduce the potential cooling surface.

EP 2 065 963 B1 describes a battery system with a battery block comprising a plurality of rectangular batteries, with a cooling plate which is in thermal contact with the bottom surface of the battery block and comprises an internal hollow region, as well as cooling tubes arranged in the hollow region. The hollow region is also filled with a foam plastic. In addition, the battery block comprises cooling spacers that are sandwiched between the rectangular batteries and are made of sheet metal.

This also allows only a relatively small region of a respective battery cell to be cooled.

Furthermore, DE 10 2021 115 657 A1 describes a traction battery module with multiple battery cells and compression elements arranged between the battery cells. In addition, the traction battery module comprises rigid cooling plates which have cooling channels for a cooling liquid, wherein between two adjacent battery cells either a cooling plate or a compression element is always arranged alternately.

This only provides an one-sided cooling of the battery cells. In addition, the provision of compression elements reduces the potential cooling surface.

### SUMMARY

The object of the present invention is to provide an inter-cell cooling unit, a battery module and a method, which allow the most efficient cooling of battery cells and which at the same time allow the most space-saving swelling compensation without reducing the cooling efficiency.

This object is achieved by an inter-cell cooling unit, a battery module and a method having the features according to the respective independent claims. Advantageous embodiments of the invention are the subject matter of the dependent claims, the description, and the figures.

An inter-cell cooling unit according to the invention for arrangement between two battery cells of a battery module comprises an outer casing which provides a first cooling side and a second cooling side opposite the first cooling side with respect to a first direction, and at least one first cooling channel section running within the outer casing, through which section a coolant can flow. In addition, the inter-cell cooling unit comprises a multi-layer compression component which is arranged within the outer casing and which comprises at least one first outer layer made of a first plastic material and a compression layer made of a second plastic material which is more compressible than the first plastic material and which is flatly adjacent to the first outer layer with respect to the first direction, wherein the at least one first cooling channel section is delimited with respect to the first direction by the outer casing on the one hand and the first outer layer on the other hand.

Due to the at least one first cooling channel section running within the outer casing, it is advantageously possible to provide a cooling function by the inter-cell cooling unit. At the same time, the inter-cell cooling unit can advantageously also be provided with good compression properties due to the multi-layer compression component arranged within the outer casing. Thus, good swelling compensation properties and a cooling function can be integrated into a common component, namely the inter-cell cooling unit. What is particularly advantageous, however, is exactly that the compression component has a multi-layer structure, comprising a less compressible outer layer and a more compressible compression layer. The at least one first cooling channel section is delimited on the one hand by the outer casing of the inter-cell cooling unit and on the other hand by the “harder” first outer layer of the compression component. The first cooling channel section can thus be formed in a space between the outer casing and the first outer layer of the compression component. The “harder” first outer layer then ensures that the compression properties of the “softer” compression layer do not have a negative effect on the cooling function. In other words, the inter-cell cooling unit can be compressed by application of an external pressure, but such compression then significantly leads to compression of the compression layer, while the harder first outer layer can largely avoid compression of the first cooling channel section or at least prevent complete compression of the first cooling channel section. This ensures that the flow through the first cooling channel section is still guaranteed even when the inter-cell cooling unit is compressed. In addition, the harder first outer layer advantageously enables force transmission from the outer casing to the compression layer when external force is applied to the inter-cell cooling unit. Because the inter-cell cooling unit combines a cooling function and compression properties in one component, it is advantageously possible to provide such an inter-cell cooling unit in a cell stack with multiple battery cells between each two battery cells arranged adjacent to one another in a stacking direction. This enables cooling of each battery cell on both sides, particularly on the sides with the largest surface region, which in turn allows particularly effective cooling of the battery cells. The integration of the compression component into the inter-cell cooling unit is also very space-saving and the potential cooling surface is not reduced.

In addition, a particularly simple production of the inter-cell cooling unit, in particular the compression component, is also possible. This can be manufactured, for example, by extrusion, as will be explained in more detail later.

The outer casing may enclose an interior space in which at least the first cooling channel section runs and in which the multi-layer compression component is also arranged. In addition, the inter-cell cooling unit may also have a coolant supply connection and a coolant discharge connection in order to introduce into and discharge from this interior space a coolant, in particular into the at least one first cooling channel section.

The first cooling channel section may represent a cooling channel or only a longitudinal section of such a cooling channel. In particular, multiple first cooling channel sections can also be integrated into the inter-cell cooling unit.

With regard to a proper installation position of the inter-cell cooling unit in a cell stack, the first direction corresponds to a stacking direction in which multiple battery cells of such a cell stack are arranged next to one another with their cell sides with the largest region opposite one another. A second direction can also be defined perpendicular to the first direction, and also a third direction which is perpendicular to the first and second direction. The multi-layer compression component can extend in the interior space of the outer casing essentially in the second and/or third direction over the entire interior space. This allows good compression properties to be provided across the entire inter-cell cooling unit.

The expression “with respect to the first direction” should be understood as in or opposite to the first direction. This applies analogously to the other directions. The fact that the compression layer is adjacent to the first outer layer with respect to the first direction means that the compression layer is adjacent to the first outer layer in or opposite to the first direction.

According to a further very advantageous embodiment of the invention, the compression component comprises at least one second outer layer made of a third plastic material and/or the first plastic material, wherein the second outer layer adjoins the compression layer over a large region in the first direction, wherein the inter-cell cooling unit comprises at least one second cooling channel section extending within the outer casing, which is delimited in the first direction by the outer casing on the one hand and the second outer layer on the other hand.

The compression component can therefore have two outer layers, each of which is less compressible than the compression layer located between these outer layers, which compression layer is therefore arranged between these two outer layers. Preferably, the two outer layers are made of the same plastic material, namely the first plastic material, but theoretically they can also be made of different plastic materials, which are then each less compressible than the second plastic material from which the compression layer is formed. The first outer layer can, for example, face the first cooling side provided by the outer casing, and the second outer layer can correspondingly face the second cooling side. The at least one first cooling channel section can thus be formed between the first outer layer and the first cooling side, and the second cooling channel section correspondingly between the second outer layer and the second cooling side. This allows both cooling sides of the inter-cell cooling unit to be cooled particularly efficiently and evenly. With respect to the first direction, the compression component is thus arranged between the at least one first cooling channel section and the at least one second cooling channel section.

In general, the inter-cell cooling unit may also comprise a plurality of first cooling channel sections and a plurality of second cooling channel sections. The first cooling channel sections are then each delimited by the outer casing on the one hand, in particular the first cooling side, and the first outer layer of the compression component on the other hand, and the second cooling channel sections are delimited by the outer casing on the one hand, in particular the second cooling side, and the second outer layer of the compression component on the other hand. The compression component is therefore located between the first cooling channel sections on the one hand and the second cooling channel sections on the other.

According to a further advantageous embodiment of the invention, the outer casing is at least partially or completely flexible. This advantageously enables compression of the inter-cell cooling unit as a whole. In particular, this makes it particularly easy to transfer a pressuring inter-cell cooling unit from the outside to the compression component located inside the outer casing. Furthermore, it is preferred that the outer casing is made of a metallic material, in particular aluminum. This allows a particularly good thermally conductive connection to be created with adjacent components to be cooled, such as battery cells. The outer casing can, for example, be formed from two shells. One of these shells can provide the first cooling side and the other the second cooling side. The two shells can be joined together in a peripheral edge region, for example by welding. Before welding, the compression component can be inserted between the shells and these can then be joined together. This enables particularly simple production of the inter-cell cooling unit.

The two cooling sides of the inter-cell cooling unit are preferably flat, in particular in an undeformed state of the inter-cell cooling unit. In particular, if the inter-cell cooling unit is arranged as intended between two battery cells, in particular two prismatic battery cells, the cooling sides can be brought into contact with the adjacent cell sides in a flat manner. Due to the flexible design of the outer casing, the shape of the inter-cell cooling unit can adapt to the changing geometry of the battery cells, even in the event of cell swelling.

According to a further advantageous embodiment of the invention, the first plastic material comprises polyamide and/or polypropylene, in particular PA6.6 and/or polyketone, or represents one of these plastics. Polyamide and/or polypropylene can be used to provide particularly “hard” outer layers. PA6.6 and/or polyketone in particular have the advantage of being resistant to typical coolants. PA6.6 is also known as nylon or polyhexamethylene adipamide. But other plastics are also conceivable.

According to a further advantageous embodiment of the invention, the second plastic material is elastic and, in particular, comprises or represents an elastic, thermoplastic plastic material, in particular a foamed plastic.

Due to the elastic properties of the second plastic material, it is possible for it to counteract an external force or pressure with a restoring force. This provides a positive contribution to the service life of the battery cells. In addition, this allows the cooling sides to be reliably pressed against the adjacent cell sides even if the geometry of the intermediate space between two battery cells changes. By using a foamed plastic, additional weight can be saved. In addition, the desired compression properties can be precisely adjusted by setting the degree of foaming.

According to a further advantageous embodiment of the invention, the first outer layer has an outer first surface opposite the first cooling side of the outer casing, which first surface comprises first regions and second regions, wherein the first surface contacts the outer casing in the first regions and the second regions adjoin first cooling channel sections of the inter-cell cooling unit, wherein the first and second regions are arranged alternately next to one another in a second direction. The first outer layer can therefore be formed with a non-planar first surface. For example, as will be explained in more detail later, this can be designed in a corrugated manner. This creates elevated and recessed surface regions. The elevated surface regions may be the first regions in direct contact with the outer casing. The recessed regions form cavities between the outer casing and these second regions, through which the first cooling channel sections are provided. Optionally, the compression component can also be joined to the outer casing in the first regions, for example by being glued or welded or similar. However, such a material-locking joint is not necessarily required. Due to the first regions and their contact with the outer casing, in particular the first cooling channel sections are separated from each other in the second direction. The first regions can be significantly smaller in size in the second direction than the second regions. For example, the first regions can also only form linear contact regions with the outer casing.

In addition, the second outer layer can be designed accordingly. Accordingly, in a further advantageous embodiment of the invention, the second outer layer has an outer second surface opposite the second cooling side of the outer casing, which second surface comprises third and fourth regions, wherein the second surface contacts the outer casing in the third regions and the fourth regions adjoin second cooling channel sections of the inter-cell cooling unit, wherein the third and fourth regions are arranged alternately next to one another in the second direction, in particular wherein a respective fourth region is opposite one of the first regions of the first surface and a respective third region is opposite a respective second region of the first surface. The third regions can be designed as already described for the first regions of the first surface. And the fourth regions can be designed as already described for the second regions of the first surface. Because in particular the fourth regions are opposite the first regions of the first surface and the third regions are opposite the second regions of the first surface, the first cooling channel sections are offset from the second cooling channel sections in the second direction. This enables a particularly space-saving arrangement.

According to a further advantageous embodiment, the first and/or second surface, in particular the first or second outer layer and/or the compression component, extends in the second direction in a corrugated or zigzag-like or meander-like manner, in particular wherein the first and second regions of the first surface, and in particular also the third and fourth regions of the second surface, extend in a straight line in a third direction. It is precisely through a corrugated or zigzag-shaped or meander-shaped course that the free spaces for the first cooling channel sections and correspondingly also for the second cooling channel sections can be created in a particularly advantageous and simple manner. Not only the respective surfaces can be corrugated or zigzag-shaped and/or meandering, but the outer layers as a whole. In particular, the outer layers can run essentially parallel to one another in a corrugated or zigzag-like or meander-like manner, which results in the compression component as a whole extending in a corrugated or zigzag-like or meander-like manner. Accordingly, the compression layer between the two outer layers can also be corrugated and/or zigzag-shaped or meander-shaped. In the third direction, the individual regions of the outer layers can run in a straight line. In other words, the compression component can have a constant cross-section perpendicular to the third direction. This enables particularly simple production of the compression component, for example by extrusion.

According to a further advantageous embodiment of the invention, the first and second outer layers are part of a second outer casing which surrounds the compression layer. The second outer casing can enclose the compression layer in a surface-contacting manner. This enables the provision of higher restoring forces due to the greater hardness of the second outer casing compared to the compression layer.

Furthermore, the invention also relates to a battery module for a motor vehicle having an inter-cell cooling unit according to the invention or one of its embodiments.

The battery module can, for example, comprise a cell stack with a plurality of battery cells arranged next to one another in a stacking direction, wherein the inter-cell cooling unit according to the invention or one of its embodiments can be arranged between two battery cells arranged adjacent to one another in the stacking direction. Such an inter-cell cooling unit can be arranged between every two battery cells arranged adjacent to each other in the stacking direction. The battery cells can be designed, for example, as prismatic battery cells or pouch cells. In particular, these can be lithium-ion cells.

Furthermore, the invention also relates to a battery for a motor vehicle which has a battery module according to the invention or one of its embodiments. The battery can be designed, for example, as a high-voltage or medium-voltage battery.

Furthermore, the invention also relates to a motor vehicle having a battery according to the invention or one of its embodiments. The motor vehicle may be designed as an electric vehicle, for example.

The motor vehicle according to the invention is preferably designed as an automobile, in particular as a passenger car or truck, or as a passenger bus or motorcycle.

Furthermore, the invention relates to a method for producing an inter-cell cooling unit, wherein an outer casing is provided which provides a first cooling side and a second cooling side. The outer casing can also be provided in the form of two shells, with each of the shells providing one of the cooling sides. Furthermore, a multi-layer compression component is provided, in particular by means of extrusion, which comprises at least a first outer layer made of a first plastic material and a compression layer made of a second plastic material, which is more compressible than the first plastic material and which adjoins the first outer layer in a planar manner. Furthermore, the compression component is arranged within the outer casing, whereby at least one first cooling channel section is formed, which is delimited by the outer casing on the one hand and the first outer layer on the other hand.

The invention also includes developments of the method according to the invention, which have features as already described in the context of the refinements of inter-cell cooling unit and the battery module according to the invention. For this reason, the corresponding developments of the method according to the invention are not described again here.

The invention also comprises the combinations of the features of the described embodiments. The invention therefore also comprises implementations which each have a combination of the features of a plurality of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic representation of a battery module according to an exemplary embodiment of the invention;

FIG. 2 shows a schematic and perspective representation of an inter-cell cooling unit according to an exemplary embodiment of the invention; and

FIG. 3 shows a schematic cross-sectional representation of an inter-cell cooling unit according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

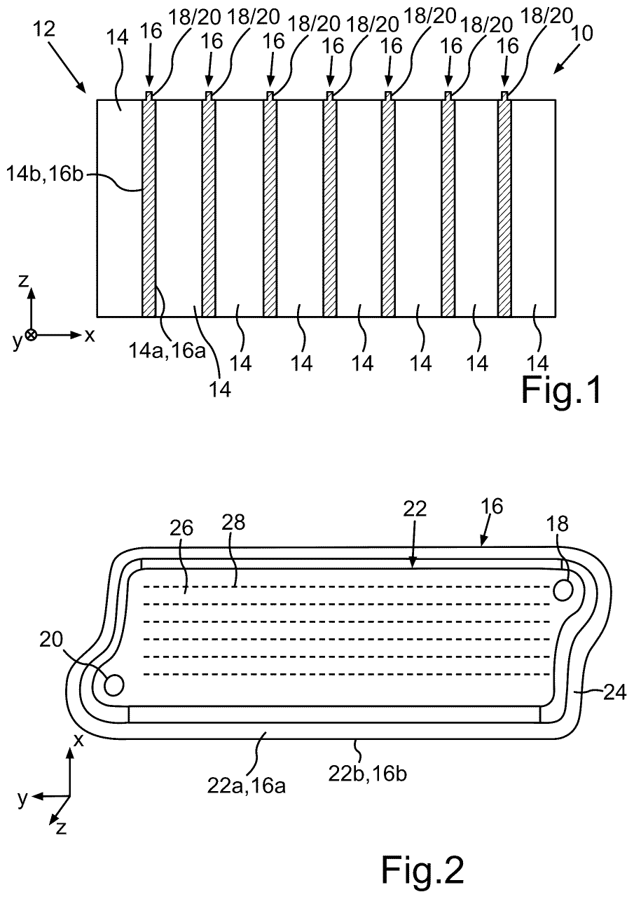

FIG. 1 shows a schematic representation of a battery module 10 according to one exemplary embodiment of the invention. The battery module 10 comprises a cell stack 12 with multiple battery cells 14 arranged next to one another in a stacking direction x. The battery cells 14 in this example are designed as prismatic battery cells 14. In the present case, these can be lithium-ion cells, for example. In the present example, an inter-cell cooling unit 16 according to an exemplary embodiment of the invention is arranged between each two battery cells 14 arranged next to one another in the stacking direction x.

The inter-cell cooling unit 16 comprises, on the one hand, a first outer side 16a, which represents a first cooling side 16a, and an opposite second outer side 16b, which represents a second cooling side 16b. When arranged as intended in a cell stack 12, these outer sides 16a, 16b adjoin the respective cell sides 14a, 14b of the adjacent battery cells 14. Such an inter-cell cooling unit 16 is also designed so that a coolant can flow through it. For this purpose, the inter-cell cooling unit 16 may comprise a coolant supply connection 18 and a coolant discharge connection 20 in order to supply a coolant, in particular a liquid coolant, to the inter-cell cooling unit 16 and to discharge it therefrom again. An inlet and outlet valve can correspondingly be integrated into the inter-cell cooling unit 16 as a coolant supply and discharge connection 18, 20.

FIG. 2 shows a schematic and perspective representation of an inter-cell cooling unit 16 according to an exemplary embodiment of the invention. The inter-cell cooling unit 16 comprises an outer casing 22 made of a metallic material. The outer casing 22 provides both the above-mentioned first cooling side 16a and the opposite second cooling side 16b. In the present case, the inter-cell cooling unit 16 is shown in a plan view obliquely from above onto the first cooling side 16a. The outer casing 22 can be formed from two shells, for example a first shell 22a and an opposite second shell 22b, which are joined together in a circumferential edge region 24. The outer casing 22 encloses an interior space in which cooling channel sections 26 run, wherein in the present case a plurality of first cooling channel sections 26 are schematically shown, which are schematically separated from one another by dashed lines. First regions 28 can run along these dashed lines, as will be explained in more detail later.

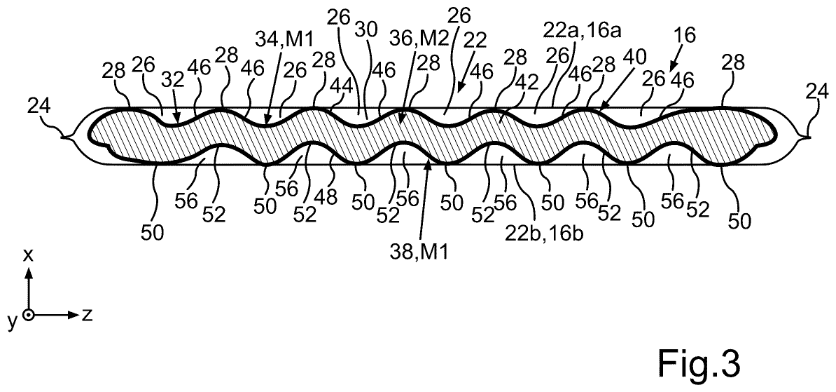

FIG. 3 shows a schematic cross-sectional representation of an inter-cell cooling unit 16 according to an exemplary embodiment of the invention. As already described, this comprises an outer casing 22, which can be composed of two shells 22a, 22b joined together in the edge region 24. The outer casing 22 accordingly encloses an interior space 30 in which a compression component 32, more precisely a multi-layer compression component 32, is arranged. This compression component 32 comprises a first outer layer 34, which is formed from a first material, in particular a first plastic material M1, a compression layer 36, which is formed from a second plastic material M2, and a second outer layer 38, which in this case is again formed from the first plastic material M1. In particular, the two outer layers 34, 38 are part of a second outer casing 40 which surrounds the compression layer 36. The interior 42 of this second casing 40 is thus filled with the compression layer 36.

The second plastic material M2 is particularly elastic and has a higher compressibility than the first plastic material M1. In addition, the first outer layer 34 has a first surface 44 which faces the first cooling side 16a and which is divided into first regions 28 and second regions 46 and which is corrugated in particular in the y-direction. In the first regions 28, the surface 44 contacts the first cooling side 16a, and the second regions 46 delimit the first cooling channel sections 26 formed between the first cooling side 16a and the first outer layer 34.

In a corresponding manner, the second outer layer 38 has a second surface 48 which is divided into third regions 50 and fourth regions 52. In the third regions 50, the second outer layer 38 contacts the second cooling side 16b, and the fourth regions 52 adjoin second cooling channel sections 56 formed between the second outer layer 38 and the second cooling side 16b. The first regions 28 are located opposite the fourth regions 52 and the second regions 46 are located opposite the third regions 50. Thus, not only the respective surfaces 44, 48 of the outer layers 34, 38 are corrugated in the z-direction, but the outer layers 34, 38 as a whole as well as the compression layer 36 and accordingly the compression component 32 as a whole. This allows a particularly space-saving arrangement.

The compression component 32 can be provided from a coextrusion material with a hard edge layer 40 and an elastic core 36, which in its geometry with its cover layer 40 made of the hard component M1 forms the cooling channels, which are referred to here as cooling channel sections 26, 56, and encloses them with a cover plate, namely the outer casing 22, made of conductive material. The cover plate or the respective outer sides 16a, 16b lie flat against the component to be cooled, in the present example against the battery cells 14.

The first material component, which can also be called a hard component, is, for example, PA6.6, polypropylene, polyketone or another plastic that is preferably resistant to the coolant that flows through the cooling channel sections 26, 56 during operation. The second material M2 is preferably an elastic thermoplastic, preferably foamed. The second plastic material M2 can therefore be a plastic foam. The metal plate or the outer casing 22 as a whole is preferably made of aluminum. The foam or generally the compression layer 36 made of the second material M2 can absorb swelling forces due to the high compressibility of this compression layer 36, in particular its elastic compressibility. The hard component 40 can be joined to a metallic cover surface 22. In other words, the second outer casing 40 can be joined to the first outer casing 22 in a fluid-tight manner in the first and third regions 28, 50, in particular by a material-locking joint, so that solid cooling channels 26, 56 are formed. The metallic cover surface 22 is preferably made of high-strength aluminum.

Overall, the examples show how the invention can be used to provide cooling plates in composite technology with tolerance compensation. Cooling channels can be formed using a co-extruded plastic plate, which are then closed with a metallic outer casing. Thus, a cooling function and good swelling compensation properties can be integrated into a component, namely the inter-cell cooling unit.

1. An inter-cell cooling unit for arrangement between two battery cells of a battery module, comprising:
an outer casing which provides a first cooling side and a second cooling side opposite the first cooling side with respect to a first direction, and
at least one first cooling channel section extending within the outer casing through which a coolant can flow,
wherein the inter-cell cooling unit comprises a multi-layer compression component which is arranged within the outer casing and which comprises at least one first outer layer made of a first plastic material and a compression layer made of a second plastic material which is more compressible than the first plastic material and which is flatly adjacent to the first outer layer with respect to the first direction, wherein the at least one first cooling channel section is delimited with respect to the first direction by the outer casing on the one hand and by the first outer layer on the other hand.

2. The inter-cell cooling unit according to claim 1, wherein the compression component comprises at least one second outer layer made of a third plastic material and/or the first plastic material, which is flatly adjacent to the compression layer with respect to the first direction, wherein the inter-cell cooling unit comprises at least one second cooling channel section extending within the outer casing, which is delimited in the first direction by the outer casing on the one hand and by the second outer layer on the other hand.

3. The inter-cell cooling unit according to claim 1, wherein the outer casing is flexible, at least in regions or completely, and is made of a metallic material, in particular aluminum.

4. The inter-cell cooling unit according to claim 1, wherein the first plastic material comprises polyamide and/or polypropylene, in particular PA6.6 and/or polyketone; and/or the second plastic material comprises or represents an elastic, thermoplastic plastic material, in particular a foamed plastic.

5. The inter-cell cooling unit according to claim 1, wherein the first outer layer has an outer first surface facing the first cooling side of the outer casing, which comprises first regions and second regions, wherein the first surface in the first regions contacts the outer casing and the second regions are adjacent to first cooling channel sections of the inter-cell cooling unit, wherein the first and second regions are arranged alternately next to each other in a second direction.

6. The inter-cell cooling unit according to claim 5, wherein the second outer layer has an outer second surface facing the second cooling side of the outer casing, which comprises third regions and fourth regions, wherein the second surface contacts the outer casing in the third regions and the fourth regions are adjacent to second cooling channel sections of the inter-cell cooling unit, wherein the third and fourth regions are arranged alternately next to each other in the second direction, in particular wherein a respective fourth region is opposite one of the first regions of the first surface and a respective third region is opposite a respective second region of the first surface.

7. The inter-cell cooling unit according to claim 6, wherein the first and/or second surface, in particular the first or second outer layer and/or the compression component extends in a corrugated manner or zigzag or meandering manner in the second direction, in particular wherein the first and second regions of the first surface extend in a straight line in a third direction.

8. The inter-cell cooling unit according to claim 2, wherein the first and second outer layer are part of a second outer casing surrounding the compression layer.

9. A battery module for a motor vehicle with an inter-cell cooling unit according to claim 1.

10. A method for producing an inter-cell cooling unit, comprising the step:
providing an outer casing which provides a first cooling side and a second cooling side,
providing a multi-layer compression component, in particular by extrusion, which comprises at least a first outer layer made of a first plastic material and a compression layer made of a second plastic material that is flatly adjacent to the first outer layer, which second material is more compressible than the first plastic material, and
arranging the compression component within the outer casing, thereby forming at least a first cooling channel section which is delimited by the outer casing on the one hand and by the first outer layer on the other hand.

11. The inter-cell cooling unit according to claim 2, wherein the outer casing is flexible, at least in regions or completely, and is made of a metallic material, in particular aluminum.

12. The inter-cell cooling unit according to claim 2, wherein the first plastic material comprises polyamide and/or polypropylene, in particular PA6.6 and/or polyketone; and/or the second plastic material comprises or represents an elastic, thermoplastic plastic material, in particular a foamed plastic.

13. The inter-cell cooling unit according to claim 3, wherein the first plastic material comprises polyamide and/or polypropylene, in particular PA6.6 and/or polyketone; and/or the second plastic material comprises or represents an elastic, thermoplastic plastic material, in particular a foamed plastic.

14. The inter-cell cooling unit according to claim 2, wherein the first outer layer has an outer first surface facing the first cooling side of the outer casing, which comprises first regions and second regions, wherein the first surface in the first regions contacts the outer casing and the second regions are adjacent to first cooling channel sections of the inter-cell cooling unit, wherein the first and second regions are arranged alternately next to each other in a second direction.

15. The inter-cell cooling unit according to claim 3, wherein the first outer layer has an outer first surface facing the first cooling side of the outer casing, which comprises first regions and second regions, wherein the first surface in the first regions contacts the outer casing and the second regions are adjacent to first cooling channel sections of the inter-cell cooling unit, wherein the first and second regions are arranged alternately next to each other in a second direction.

16. The inter-cell cooling unit according to claim 4, wherein the first outer layer has an outer first surface facing the first cooling side of the outer casing, which comprises first regions and second regions, wherein the first surface in the first regions contacts the outer casing and the second regions are adjacent to first cooling channel sections of the inter-cell cooling unit, wherein the first and second regions are arranged alternately next to each other in a second direction.
